(19) United States
(12) Patent Application Publication
(10) Pub. No.: US 2025/0214168 A1
(43) Pub. Date: Jul. 3, 2025

(54) System and Method for Wire-Arc Additive Manufacturing Without Shielding Gas for Improved Infill Deposition Rate and Production Accuracy

(71) Applicant: C. F. Gosser, Snohomish, WA (US)

(72) Inventor: C. F. Gosser, Snohomish, WA (US)

(21) Appl. No.: 18/962,285

(22) Filed: Nov. 27, 2024

Related U.S. Application Data
(60) Provisional application No. 63/616,416, filed on Dec. 29, 2023.

(51) Int. Cl. B23K 9/04; B23K 9/14; B23K 31/02; B23K 35/02; B33Y 30/00; B33Y 50/00

(52) U.S. Cl. CPC B23K 9/042; B23K 9/14; B23K 31/02; B23K 35/0266; B33Y 30/00; B33Y 50/00

(57) ABSTRACT

A system and method for wire-arc additive manufacturing to provide a wire-arc additive manufacturing device having a self-shielding system with a gantry and a computer numerical control type control system which enables precise infill patterns not normally obtainable with robotic control, whereby the additive manufacturing system includes a metal deposition device configured to deposit a metal material during an additive manufacturing process, whereby a controller may be operatively coupled to the metal deposition device to command the metal deposition device to deposit an infill pattern based on one or more stored patterns.

### CROSS-REFERENCE TO RELATED APPLICATION

This application claims priority to U.S. Provisional Patent Application No. 63/616,416 filed on Dec. 29, 2023, which is incorporated by reference herein in its entirety.

### FIELD OF DISCLOSURE

The overall field of this invention is for a robotic welding system and more particularly a robot welding system that is a self-shielding and uses a flux cored arc welding device with a continuously fed wire to implement an infill pattern unachievable by manual arc manipulation.

### BACKGROUND

Welding infill patterns are commonly used in metal three dimensional printing, also known as additive manufacturing. These patterns are designed to provide structural integrity, reduce material usage, and control build times. However, there can be problems associated with welding infill patterns in metal three dimensional printing. Selecting the appropriate infill pattern for a specific part can be challenging. The optimal pattern can vary based on factors like the part's geometry, intended use, and material being used. Determining the best pattern often requires careful analysis and experimentation. Previous technologies implement manual operations for infill patterns but are limited by humans which require experience, cannot implement an infill pattern that a machine can do, and can only weld for so many feet until no longer being able to compete the task. Other technologies use cover gases that are limited by indoor use and requires excessive cleaning and machining between layers. Thus exists the need for a new system and method for wire-arc additive manufacturing without shielding gas for improved structural parameters

### SUMMARY

It is an object of the present invention to provide a wire-arc additive manufacturing to provide a wire-arc additive manufacturing device having a self-shielding system with a gantry and a computer numerical control type control system which enables precise infill patterns not normally obtainable with robotic control. The present invention uses semi-automatic weld parameters to advance the abilities of wire-arc additive manufacturing through the integration of repeating human-like infill patterns for improved microstructural properties.

In one embodiment, the additive manufacturing system includes a metal deposition device configured to deposit a metal material during an additive manufacturing process. A controller may be operatively coupled to the metal deposition device to command the metal deposition device to deposit an infill pattern based on one or more stored patterns. During the welding sequences, the way in which multiple beads are laid down in a weld joint to fill is strategically planned to control factors like heat input, distortion, and the overall quality of the weld while providing a repeating human like infill pattern that improves replication and better prepares sequential multirow welding.

### BRIEF DESCRIPTION OF DRAWINGS

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The present invention will be described by way of exemplary embodiments, but not limitations, illustrated in the accompanying drawings in which like references denote similar elements, and in which:

FIG. 1 is an illustration of a non-limiting embodiment of the robotic welding system.

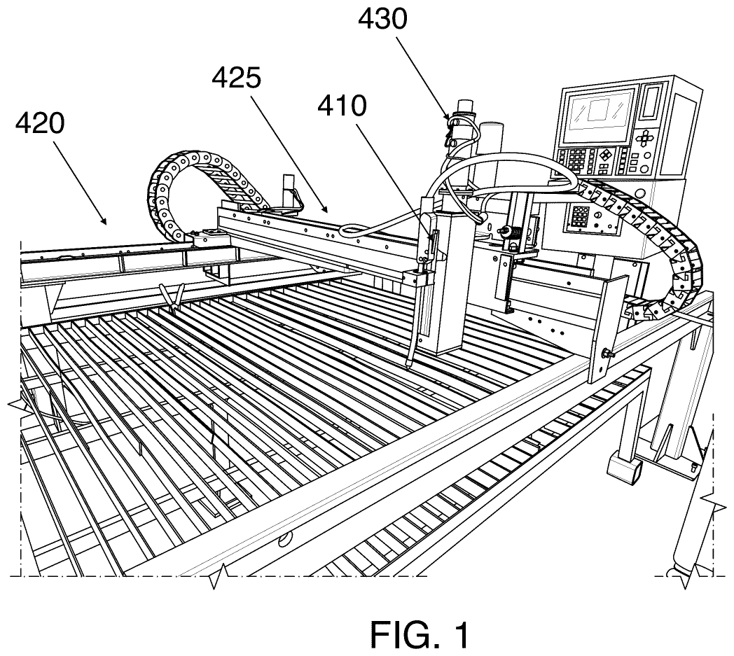

FIG. 2 is an illustration of the non-limiting embodiment of the robotic welding system in FIG. 1.

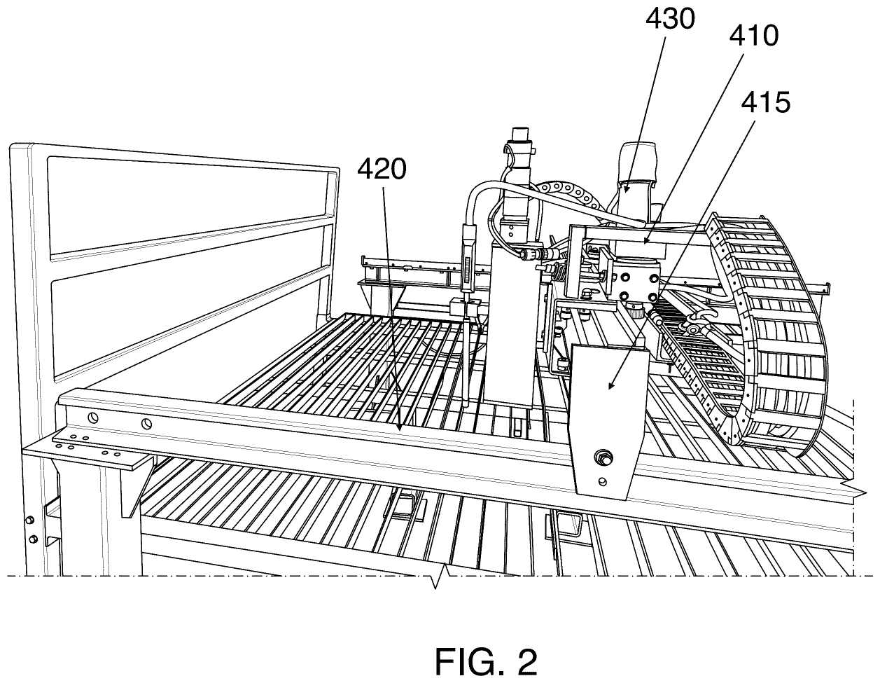

FIG. 3 is an illustration of the non-limiting embodiment of the robotic welding system in FIG. 1.

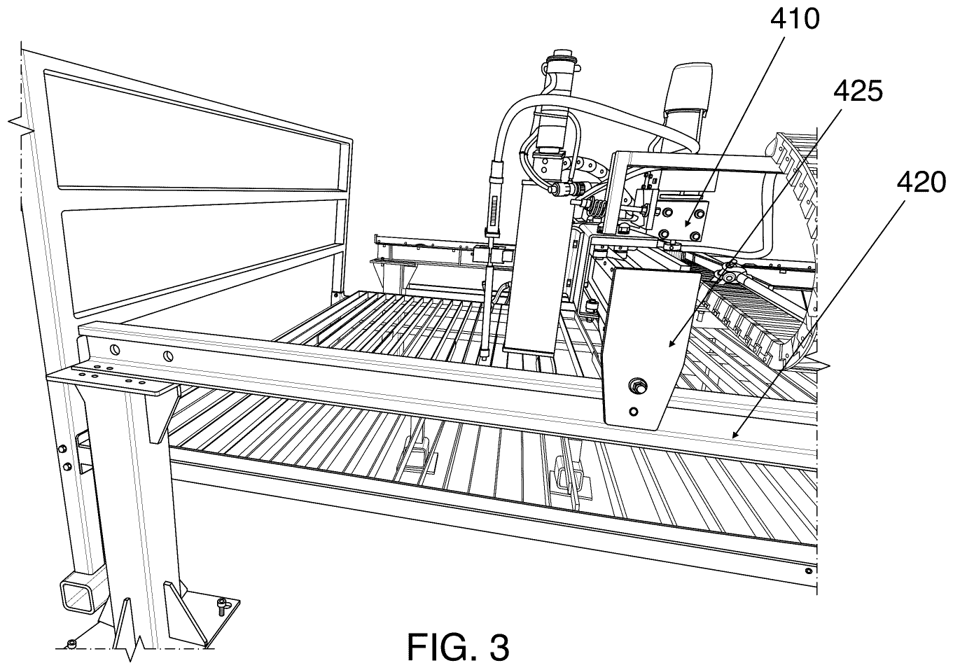

FIG. 4 is a block diagram of a non-limiting embodiment of the robotic welding system.

FIG. 5 is a block diagram of a non-limiting embodiment of a computing device of the robotic welding system.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following detailed description, numerous specific details are set forth in order to provide a more thorough understanding of the one or more embodiments described herein. However, it will be apparent to one of ordinary skills in the art that the invention may be practiced without these specific details. In other instances, well-known features have not been described in detail to avoid unnecessarily complicating the description.

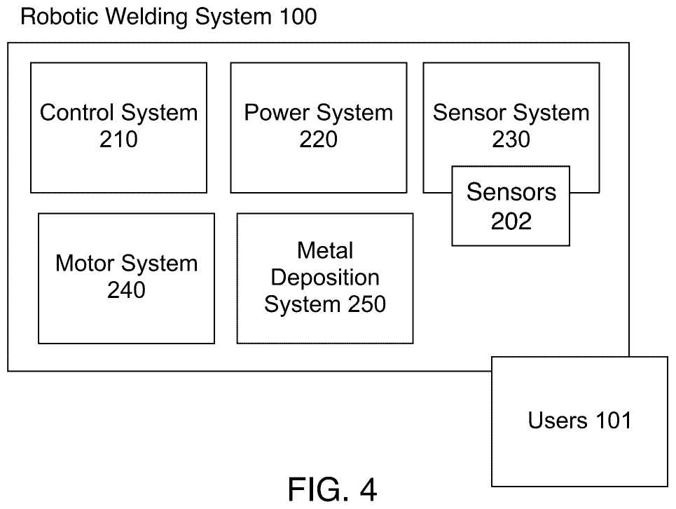

Robotic welding system 100 may be utilized by a one or more users 101 as illustrated in FIG. 4. Robotic welding system 100 may have a plurality of systems including a control system such as a control system 210, a power system 220, a sensor system 230, a motor system 240, and metal deposition system 250, which may be integrated in combination within the structure of robotic welding system 100 and utilized by users 101. The various systems may be individually configured and correlated with respect to each other so as to attain the desired objective of providing a robotic welding system 100.

Power system 220 of robotic welding system 100 may provide the energy to robotic welding system 100 including the circuits and components of control system 210 during operation of robotic welding system 100. Robotic welding system 100 may be powered by methods known by those of ordinary skill in the art such as a power cord or generator for portability and outdoor use. In some embodiments, power system 220 may include a generator whereby the generator is of a charge, design, and capacity, to provide sufficient power to robotic welding system 100 and the circuits and components of control system 210 while robotic welding system 100 is running for a set period of time.

Control system 210 may operate to control the actuation of the other systems. Control system 210 may have a series of computing devices which will be discussed in detail later in the description. Control system 210 may be in the form of a circuit board, a memory or other non-transient storage medium in which computer-readable coded instructions are stored, and one or more processors configured to execute the instructions stored in the memory. Control system 210 may have a wireless transmitter, a wireless receiver, and a related computer process executing on the processors.

Computing devices of control system 210 may be any type of user computing device that typically operates under the control of one or more operating systems which control scheduling of tasks and access to system resources. The computing devices may be a phone, tablet, television, desktop computer, laptop computer, gaming system, wearable device electronic glasses, networked router, networked switch, networked bridge, or any user computing device capable of executing instructions with sufficient processor power and memory capacity to perform operations of control system 210.

The computing devices may be integrated directly into control system 210, while in other non-limiting embodiments, control system 210 may be a remotely located user computing device or server configured to communicate with one or more other control systems 210 in robotic welding system 100. Control system 210 may also include an internet connection, network connection, and/or other wired or wireless means of communication (e.g., LAN, etc.) to interact with other components. These connections allow users to update, control, send/retrieve information, monitor, or otherwise interact passively or actively with control system 210 such as for sending commands for infill patterns.

Control system 210 may include control circuitry and one or more microprocessors or controllers acting as a servo control mechanism capable of receiving input from various components of robotic welding system 100 including motor system 240 and metal deposition system 250. The microprocessors (not shown) may have on-board memory to control the power that is applied to the various components, power system 220, motor system 240, and metal deposition system 250 in response to input signals from the users and the various components of robotic welding system 100.

Robotic welding system 100 may include one or more control panels that are touch panels on the front and a display behind the touch panel that extend from the main body of robotic welding system 100 where the users may input desired infill patterns or update them in real time. The control panels may be a light emitting diode (LED) monitor; however, this is non-limiting and the control panel may be a cathode ray tube (CRT) or a liquid crystal display (LCD). The control panels may also have cover glass bonded to a top surface of a touch panel using adhesive or any other fastening methods known by those of ordinary skill in the art. The control panels may have any number of covers to protect control panels from elements such as the weather.

The control panels may have capacitive sense capabilities, whereby when users touch the touch panel, properties of the charged touch panel are altered in that spot, thus registering where the control panel was touched allowing the user to navigate through programs, routines, and exercise to perform. The control panel may include one or more keyboards or mouses or buttons along the exterior of the display including a power button for exiting and/or deactivating robotic welding system. Control system 210 may include circuitry to provide an actuable interface for users to interact with, including switches and indicators and accompanying circuitry for the control panel. In further embodiments, a control panel may be on a remote computing device such as a mobile phone or tablet or device whereby a user may control the settings from a distance over a network.

Control system 210 may be preprogrammed with any reference values by any combination of hardwiring, software, or firmware to implement various operational modes which may be stored locally or remotely whereby the code is collected from a connected remote device or database. One or more infill patterns or designs may be created using various computer aided design software. This design may then be converted into a set of operational instructions using any manufacturing software.

Motor system 240 may have a carriage 410 that is a moving component designed to carry metal deposition system 250 for positioning infill patterns on the base material or substrate. For each axis, there are dedicated rails or guideways 420 on which the carriage 410 moves. These rails 420 ensure smooth and precise movement. Rails 420 may be assembled together to form a unitized monorail structure. More specifically, rails 420 which extend substantially the length of robotic welding system 100 and may be permanently connected to each other using one or more connectors to create a structurally robust monorail structure upon which carriage 410 may slide or transverse in three dimensional directions. For instance, one or more base rails 420 may extend between the top end and the bottom end and the side ends to act as support. Another rail 415 may generally movably be secured to the base rails along the one or more rails so as to slide between the left side and right side or the top end and bottom end of robotic welding system 100.

Motor system 240 may have one or more motors 430 which can be a stepper motor, servo motor, or linear motor, depending on the precision and speed requirements which are connected to power system 210. Motor system 240 may have a drive mechanism which can be a lead screw, ball screw, belt drive, or direct drive system. Motor system 240 may have an x-axis actuator that moves the carriage left and right, a y-axis actuator that moves the carriage forward and backward, and a z-axis actuator that moves the carriage 410 up and down. In further embodiments motor system 240 may have one or more actuators to control the orientation and angle of the carriage.

Control system 210 may receive input commands (e.g., desired position or speed) and sends appropriate signals to the motor drivers which convert control system 210 signals into power signals that drive the motors. Each axis may contain a dedicated driver and reduction gear drives for stability and control.

Motor system 240 may have one or more limit switches positioned at the ends of each axis to prevent the carriage from moving beyond its designated limits. Motor system 240 may have an emergency stop that allows for the immediate shutdown of all motors in case of an emergency. Motor system 240 may have one or more brakes for when the carriage needs to be held in a specific position without drift.

In operation, when a command is given, control system 210 interprets the command and sends appropriate signals to each motor driver, which in turn actuates its respective motor. By coordinating the movement of the three actuators, the carriage can be positioned anywhere within the three-dimensional space defined by the lengths of the rails.

Metal deposition system 250 may be designed to provide an electric arc that is generated between a continuously fed wire electrode and the substrate (the base material or previously deposited layer). As the wire is melted by the arc, it's deposited onto the substrate. The process is controlled and guided based on the 3D model of the desired part, building it layer by layer. Metal deposition system 250 may include an electrode head that concurrently houses an array of electrodes that are consumable welding wires that are connected to power system 210. The welding wires may be continuously fed, periodically fed, or fed based on a predetermined order depending on the pattern required and the commands from control system 210. Wire feed may be controlled by a device such as the Lincoln Electric® LN-25.

The electrodes are designated to be self-shielded with flux cored wires whereby they produce their own protective shield from the surrounding atmosphere, eliminating the need for an external shielding gas. The electrode head houses the array such that electrodes are in a spaced apart configuration for controllably depositing material as part of forming a layer of a 3D object. One or more drive rolls may be used to drive the electrodes through the electrode head at a specific rate. In one embodiment, the electrodes may be driven at substantially the same rate. In another embodiment, each electrode may be driven at a respective rate that can be predetermined or dynamically identified during the additive manufacturing procedure by control system 210 depending on material composition, type of weld, welding parameters, workpiece/substrate, and other factors.

In one or more embodiments, sensor system 230 may have one or more sensors 202 mounted on components of robotic welding system 100. Sensor data may be received by control system 210 or remotely be received by a server, whereby sensor data is analyzed by control system 210 and the corresponding action or event is determined in response. Sensors 202 may be any type of sensor or combinations thereof. Examples of sensors 202 may include temperature sensors, pressure sensors, GPS, Local Positioning System (LPS), altimeters, which can identify where the components are located in a space, motion sensors (e.g., accelerometers or pedometers), which can generate data associated with the orientation and direction of motor system 240.

For instance, sensor system 230 may have one or more sensors designed to detect at least one of a location of the electrode head on the base/substrate or part, an alignment of at least one electrode of the array compared to the base/substrate or part, or a nonalignment of at least one electrode of the array compared to the base/substrate or part. The sensors may be connected to an electrode head or carriage at a location in order to detect a location of the electrode head in reference to the base/substrate or part. Sensor system 230 may have one or more encoders attached to the motor or drive mechanism to provide real-time data about the carriage's position for precise positioning or feedback. Sensor system 230 may use one or more temperature sensors to monitor all of the stages to hydrogen cracking and insufficient penetration to the base metal whereby the system may shut down or a notification may be transmitted through the control panel.

Robotic welding system may utilize various infill patterns, each with its advantages depending on the application. Typically using with robotic welding system 100, to fill groove joints with two or more base metal fusion surfaces, the infill pattern only requires three passes, a root pass, a fill pass, and a cover pass. A fourth pass is required for base material thickness in excess of one inch. For additive manufacturing on a single fusion surface or substrate, any three infill patterns may be used depending on the desired thickness of the final project.

For example, one infill pattern may be a wave pattern. The infill Pattern changes the overall heat input, height of the weld row, and depth of weld penetration. For fully automatic processes the system (may) implicitly add different levels of weaves to the fill to increase penetration at the root, bridge gaps in fill passes to finish a row or intentionally section a row, and a slight weave can be used on the cover when a partial pass is required.

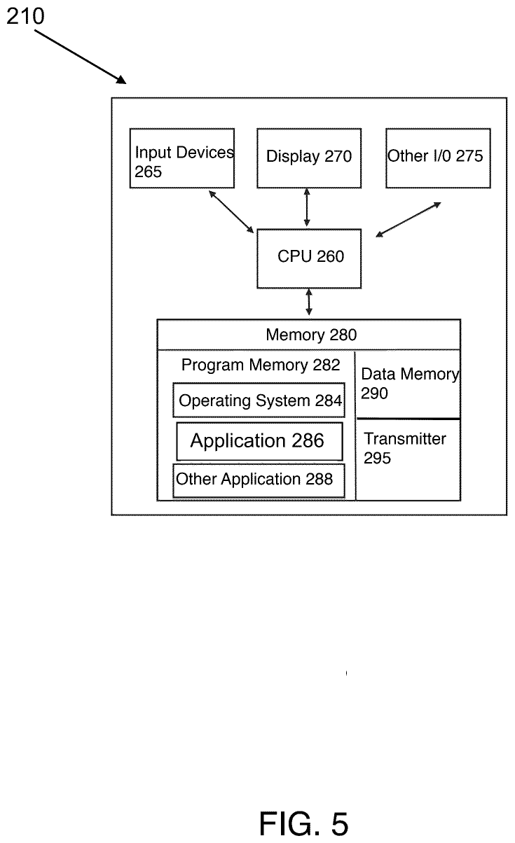

Turning to FIG. 5, FIG. 5 is a block diagram showing various components of one embodiment of a computing device 110. Computing device 110 may comprise a housing for containing one or more hardware components that allow access to edit and query communication system 230. Computing device 110 may include one or more input devices such as input devices 265 that provide input to a CPU (processor) such as CPU 260 of actions related to user 101. Input devices 265 may be implemented as a keyboard, a touchscreen, a mouse, via voice activation, wearable input device, a camera a trackball, a microphone, a fingerprint reader, an infrared port, a controller, a remote control, a fax machine, and combinations thereof.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices.

Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programing interface (API), such as API 286, and other computerized programs or application programs such as application programs 288. Memory 280 may also include data memory such as data memory 290 that may include database query results, configuration data, settings, user options, user preferences, or other types of data, which may be provided to program memory 282 or any element of computing device 110.

Computing device 110 may have a transmitter 295, such as transmitter 295, to transmit data. Transmitter 295 may have a wired or wireless connection and may comprise a multi-band cellular transmitter to connect to the server 300 over 2G/3G/4G cellular networks. Other embodiments may also utilize Near Field Communication (NFC), Bluetooth, or another method to communicate information.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A robotic welding system for wire-arc additive manufacturing, comprising: a) a metal deposition device configured to deposit metal material during an additive manufacturing process; b) a controller operatively coupled to the metal deposition device; c) a motor system configured to move the metal deposition device in three dimensions; and d) a self-shielding flux cored wire electrode; wherein the controller is configured to command the metal deposition device to deposit an infill pattern based on one or more stored patterns.

2. The system of claim 1, further comprising a sensor system configured to detect at least one of: a) a location of the metal deposition device relative to a substrate; b) an alignment of the electrode relative to the substrate; or c) a temperature of the deposited material.

3. The system of claim 1, wherein the motor system comprises: a) an x-axis actuator for moving the metal deposition device left and right; b) a y-axis actuator for moving the metal deposition device forward and backward; and c) a z-axis actuator for moving the metal deposition device up and down.

4. The system of claim 1, wherein the controller is configured to implement a repeating human-like infill pattern.

5. A method for controlling a robotic welding system with a three-dimensional rail guide, comprising: a) receiving instructions for depositing metal material; b) interpreting the instructions to determine required movements of a metal deposition device; c) sending control signals to actuators of the rail guide to move the metal deposition device in three dimensions, wherein the rail guide comprises: i) a base rail; ii) a transverse rail movably secured to the base rail; iii) a carriage movably secured to the transverse rail; and d) depositing metal material according to the instructions while moving the metal deposition device.

6. The method of claim 5, further comprising coordinating movement of: a) an x-axis actuator for moving the carriage along the transverse rail; b) a y-axis actuator for moving the transverse rail along the base rail; and c) a z-axis actuator for adjusting a height of the metal deposition device relative to the carriage.

7. The method of claim 6, further comprising monitoring a position of the carriage using one or more encoders and adjusting the control signals based on encoder feedback.

8. The method of claim 7, further comprising receiving real-time feedback from one or more sensors and adjusting operational instructions based on the feedback.

9. A robotic welding system for wire-arc additive manufacturing, comprising: a) a metal deposition device configured to deposit metal material; b) a three-dimensional rail guide system, comprising: i) a base rail extending between a top end and a bottom end; ii) a transverse rail movably secured to the base rail; iii) a carriage movably secured to the transverse rail; c) a controller operatively coupled to the metal deposition device and the rail guide system; wherein the metal deposition device is mounted on the carriage, allowing three-dimensional movement of the metal deposition device.

10. The system of claim 9, wherein the rail guide system further comprises: a) an x-axis actuator for moving the carriage along the transverse rail; b) a y-axis actuator for moving the transverse rail along the base rail; and c) a z-axis actuator for adjusting a height of the metal deposition device relative to the carriage.

11. The system of claim 10, wherein each actuator comprises: a) a motor; b) a drive mechanism selected from the group consisting of a lead screw, a ball screw, a belt drive, and a direct drive system; and c) a motor driver for converting control signals into power signals to drive the motor.

12. The system of claim 11, further comprising one or more limit switches positioned at ends of each rail to prevent the carriage from moving beyond designated limits.

13. The system of claim 12, wherein the rail guide system comprises a unitized monorail structure with permanently connected rails.

14. The system of claim 13, further comprising one or more encoders attached to the rail guide system to provide real-time data about the carriage's position.
